(19) United States
(12) Patent Application Publication
(10) Pub. No.: US 2006/0163859 A1
(43) Pub. Date: Jul. 27, 2006

(54) Stabilizing jack

(76) Inventors: Gary Lehman, Corvallis, OR (US); Bert Meijer, Overdinkel (NL); Haiko Freriksen, Hengelo OV (NL)

Correspondence Address: QUARLES & BRADY LLP, 411 E. WISCONSIN AVENUE, SUITE 2040, MILWAUKEE, WI, 53202-4497, US

(21) Appl. No.: 11/289,209

(22) Filed: Nov. 29, 2005

Related U.S. Application Data
(63) Continuation-in-part of application No. 11/184,141, filed on Jul. 19, 2005.
Application No. 11/184,141 is a division of application No. 10/695,268, filed on Oct. 28, 2003, now Pat. No. 6,932,403.
Application No. 10/695,268 is a continuation-in-part of application No. 10/301,120, filed on Nov. 21, 2002, now Pat. No. 6,655,723.
(60) Provisional application No. 60/631,404, filed on Nov. 29, 2004.
(60) Provisional application No. 60/332,161, filed on Nov. 21, 2001.

(51) Int. Cl. B60S 9/02

(52) U.S. Cl. 280/764.1

(57) ABSTRACT

A dual jack has a linear actuator guided in a track of the jack with opposite ends of the actuator connected to opposite legs of the jack to extend and retract the legs. Two dual jacks can be powered with a single pump providing fluid under pressure to the two actuators through a flow divider circuit to provide synchronized extension and retraction of all four legs of the two jacks.

### CROSS-REFERENCE TO RELATED APPLICATION

This application claims the benefit of U.S. Provisional Patent Application 60/631,404 filed Nov. 29, 2004, and is a continuation-in-part of pending U.S. patent application Ser. No. 11/184,141 filed on Jul. 19, 2005 which is a divisional of U.S. Pat. No. 6,932,403 issued Aug. 23, 2005, which is a continuation-in-part of U.S. Pat. No. 6,655,723 issued Dec. 2, 2005, which claims the benefit of U.S. Provisional Patent Application No. 60/332,161 filed on Nov. 21, 2001.

### STATEMENT CONCERNING FEDERALLY SPONSORED RESEARCH OR DEVELOPMENT

Not applicable.

### FIELD OF THE INVENTION

This invention relates to jacks for recreational vehicles and more particularly to a two-legged stabilizing jack.

### BACKGROUND OF THE INVENTION

Recreational vehicles such as trailers and motor homes are often parked at campsites, in fields, and in other locations where the ground may or may not be level. When parked in such a location, the floor of the recreational vehicle is typically not level. Furthermore, because of the suspension in the vehicle, the floor may shift, bounce or change position significantly when occupants walk around inside.

To prevent these problems, leveling devices or stabilizing jacks are used. These devices typically jack up the corners of the vehicle to limit the springiness of the suspension such that the floor of the vehicle is relatively stable, and are typically provided on all four corners of the vehicle. Often, these devices are manual jacks which require the vehicle operator to physically level the vehicle at all four corners using ratcheting or other types of manual jacking devices whenever the vehicle is parked for use. These types of devices are time consuming, difficult to operate, and can induce additional problems during set-up of the vehicle. Furthermore, when the legs are jacked independently, the corners of the vehicle can become offset, further destabilizing the vehicle.

To alleviate these difficulties, power mechanisms for leveling recreational vehicles have also been developed. One such mechanism is disclosed, for example, in U.S. Pat. No. 6,224,102 and another in U.S. Pat. No. 6,494,487. In these types of systems, two legs are extended at opposite ends of a mechanism by a single power actuator, thereby decreasing the amount of time and work required to stabilize the vehicle when parked. However, because the ground is often uneven at campsites, one of the two legs may hit the ground before the other. Therefore, these devices require complicated structures to assure that the legs are properly deployed. Furthermore, when the sets of legs are jacked independently, the vehicle can become unstable, as described above. The present invention addresses these problems.

### SUMMARY OF THE INVENTION

The invention provides a two-legged or dual stabilizer jack in which a single hydraulic actuator extends two legs at opposite ends of the jack and compensates for differences in the elevation of the point of contact of the two legs. The actuator operates and is guided along a main track, having one end secured to one leg and the other end secured to the other leg. The ends of the legs translate along with the ends of the actuator guided by the track. Links connect each leg so that as the inner ends of the legs are pushed outwardly by the actuator, the legs swing down so as to extend. If one leg hits the ground before the other, the extension of that leg will stop and extension of the other leg will accelerate. When both legs touch down and the pressure in the cylinder has reached the desired level or the elevation of the vehicle has reached the desired level, the system can automatically shut off or be manually shut off.

In another aspect, two such jacks can be simultaneously extended in substantial unison using a single hydraulic pump and a flow divider to channel flow to the two jacks simultaneously with substantially equal flow to each actuator.

In another aspect of the invention, a jack of a type having a rail with a leg pivotally connected at each end of the rail is provided. Inner ends of the legs are guided in a track of the rail so as to move linearly in the track. A linear actuator moves the ends of the legs toward and away from one another to retract and extend the legs.

The linear actuator can be a hydraulic actuator, and can include a cylinder, with both ends of the cylinder guided in the track. The rail can be a four-sided rail, having a central slot formed in a bottom side of the rail to provide the track.

In yet another aspect of the invention, a stabilizer jack is provided comprising an elongate rail including a track, an actuator movably received in the track, and a first leg and a second leg. An inner end of each of the first and second legs is pivotally coupled to opposing ends of the actuator within the track. The actuator is selectively activated to cause the legs to move linearly in the track away from one another and to pivot between a stored position wherein the legs are substantially parallel to the rail and an extended position in which the legs are pivoted downward to drive an outer end of each leg toward a surface below the rail.

The stabilizer jack can also include a first and a second roller, the first and second rollers being coupled to the inner ends of the corresponding first and second legs and to opposing ends of the actuator for guiding the actuator and the legs in the track. The actuator can also include a cylinder, with opposing ends of the cylinder guided in the track. The inner end of the first leg can be coupled to a piston rod extending from a rod end of the cylinder and the inner end of the second leg can be coupled to a base end of the cylinder.

The stabilizer jack can also include a first and a second foot, the first and second foot being pivotally coupled to an outer end of the corresponding first and second leg. A link can be pivotally coupled between the rail and each of the legs to limit the rotational motion of the legs in the extended position.

In another aspect of the invention, a jacking system for a recreational vehicle is provided. The jacking system includes both a first jack and a second jack, each jack having a rail including a track for receiving a dual-acting cylinder. First and second legs are provided in each track having their inner ends pivotally connected at each end of the cylinder such that the legs are guided in the track of the rail to move linearly toward and away from one another between a retracted and an extended position as the cylinder is retracted and extended, respectively. A flow divider circuit including at least two fluid ports is in fluid communication with the dual-acting cylinder such that the one port is in communication with the first jack and the other is in fluid communication with the second jack. The flow divider equalizes the flow of fluid flowing through the ports at substantially equal flow rates regardless of the fluid pressure in the cylinders to synchronize movement of the first and second cylinders. The first jack can be coupled to a first end of a recreational vehicle, and the second jack to an opposing end of the recreational vehicle.

These and other advantages of the invention will be apparent from the detailed description and drawings.

### BRIEF DESCRIPTION OF THE DRAWINGS

FIG. 1 is a perspective view of a recreational vehicle incorporating the jacks of the present invention;

FIG. 2 is a perspective view of a jack, and of a pump and switch for operating the jack;

FIG. 3 is a front plan view of the jack of FIG. 1;

FIG. 4 is a top view of the jack;

FIG. 5 is an end view of the jack;

FIG. 6 is a sectional view through the track taken along the line 6-6 of FIG. 3;

FIG. 7 is an exploded perspective view of the jack;

FIG. 8 is a view like FIG. 3 but with the jack legs shown extended in phantom;

FIG. 9 is a hydraulic circuit of a flow divider circuit that can be used with two jacks provided at the front and back of the vehicle as shown in FIG. 1.

### DETAILED DESCRIPTION OF THE PREFERRED EMBODIMENT

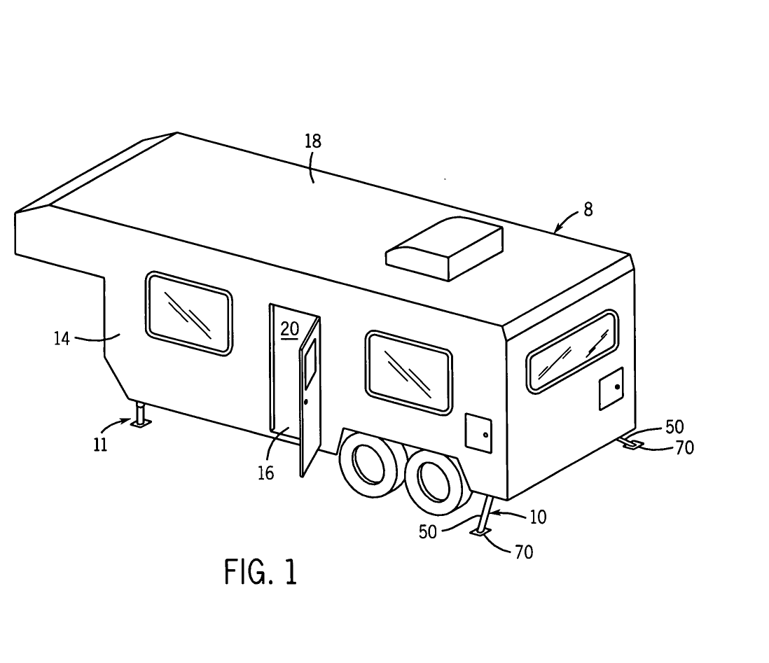

Referring now to the Figures and more particularly to FIG. 1, a recreational vehicle 8 is shown. The recreational vehicle 8 includes exterior walls 14 surrounding a stationary floor 16 covered by a vehicle roof 18 to define a vehicle interior 20. First and second dual stabilizing jacks 10 and 11, respectively, are located beneath the stationary floor 16 at opposing ends of the vehicle 8. Each stabilizing jack 10 and 11 includes first and second legs 50 and associated feet 70. The legs 50 and feet 70 are provided at opposing corners of the recreational vehicle, and are selectively extended to the ground for leveling the recreational vehicle 8, as described below.

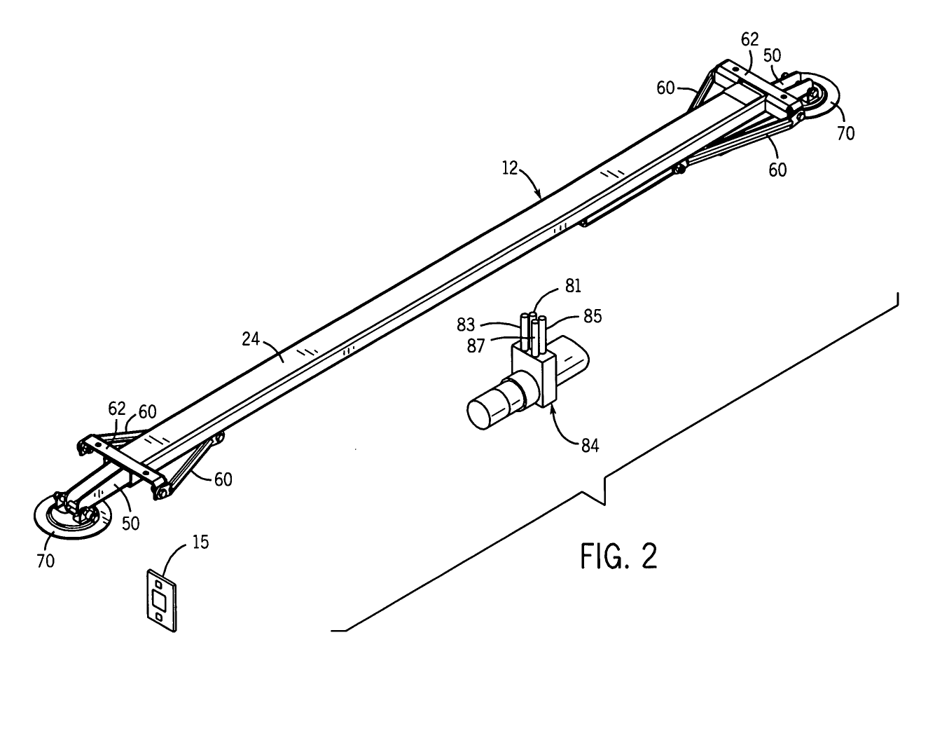

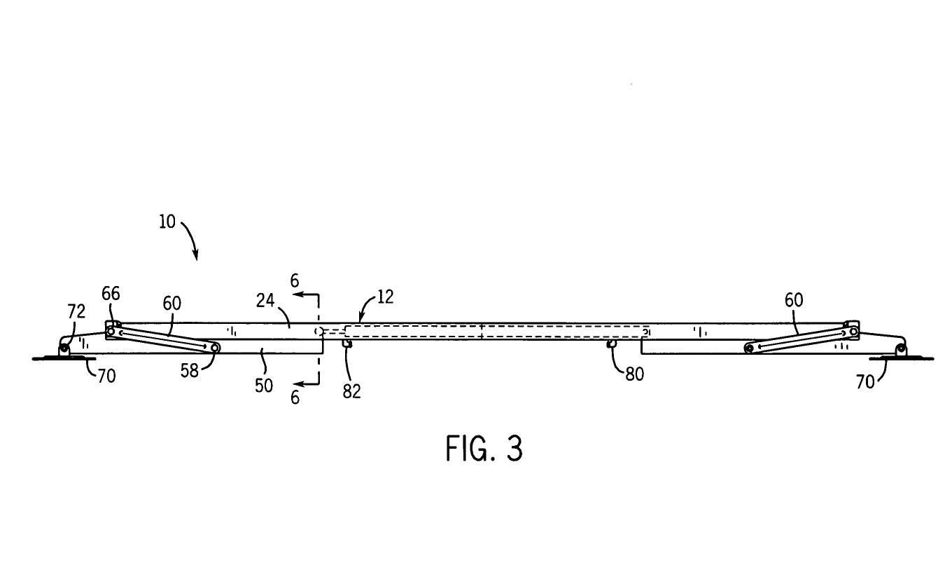

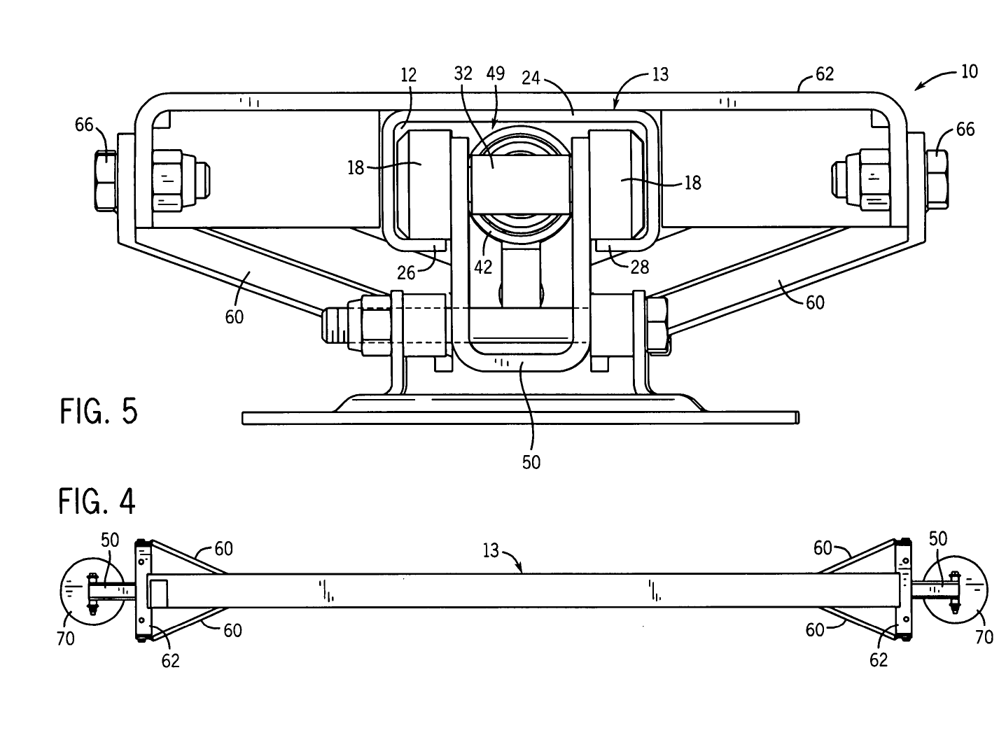

Referring now also to FIGS. 2-4, the jack 10 of the invention includes a rail 13 sized and dimensioned to extend substantially from one side of the recreational vehicle 8 to another and having brackets 62 coupled at each end. The brackets 62 extend outwardly from the opposing sides of the rail 13, and a link 60 is pivotally coupled at a first end to the portion of the bracket 62 extending from the rail 13, and at the opposing end to a leg 50. The leg 50 is generally channel-shaped with the opening in the channel opening upwardly, and is coupled at the distal end to a foot 70, as described below.

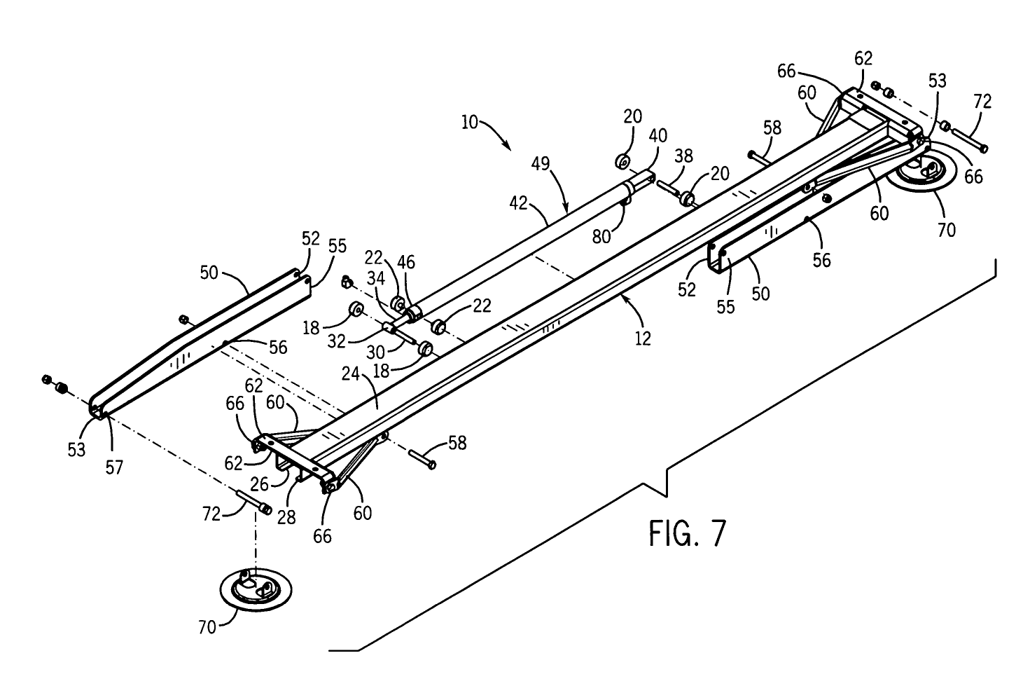

Referring now specifically to FIGS. 5-7, the rail 13 is generally shaped like a rectangular tube, and includes a central longitudinal slot 27 formed in the bottom wall of the tube, resulting in two flanges 26 and 28 extending inwardly from the side walls of the rail 13 and forming a track 12 sized and dimensioned to receive an actuator 49 and the legs 50. Referring now specifically to FIG. 7, the actuator 49 includes a double acting cylinder 42 having a first end 40 and a second end 46, and a piston rod 34 extending from end 46. Referring again to FIG. 2, the actuator 49 is preferably a hydraulic actuator driven by a pump 84, and includes an extend or bore side port 80 at the end 40 and a retract or rod side port 82 at the end 46. Pressurizing port 80 while opening port 82 to tank extends the actuator 49, and pressurizing port 82 while opening port 80 to tank retracts the actuator 49.

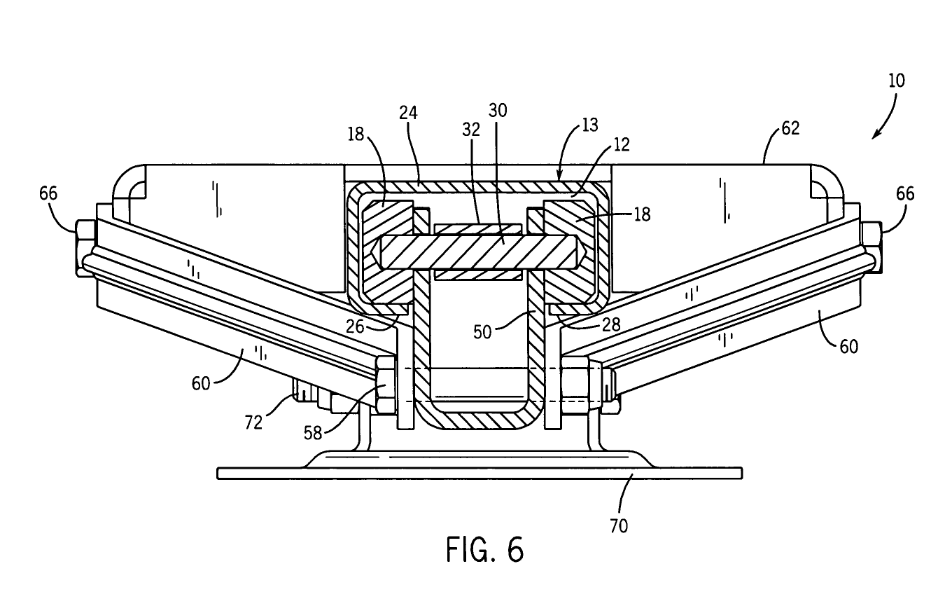

Referring again to FIG. 7, each leg 50 has three pairs of holes 55, 56, and 57, the pairs of holes 55 and 57 being provided at opposing ends 52 and 53 of each leg 50, and the holes 56 being disposed between holes 55 and 57, and preferably provided at an approximate center of the leg 50. At the inner end 52 of the left leg 50, a pin 30 extends through the holes 55 and into a mating hole formed in the end 32 of the piston rod 34, coupling the leg 50 to the actuator 49. Rollers 18, sized and dimensioned to roll in the track 12 provided between the top wall 24 of the member 12 and the flanges 26 and 28 at the bottom of the rail 13 (FIGS. 5 and 6), are pressed onto the ends of pin 30. A pin 38 similarly extends through holes 55 in the inner end 52 of the right leg 50, and into a mating hole formed in the end 40 of the cylinder 42, and rollers 20 are pressed onto the opposite ends of pin 38. Therefore, the inner end 52 of the right legs 50 are coupled to the piston rod 34 and base end 40 of opposing ends of the actuator 49. Thus, when the actuator 49 is extended, the inner ends 52 of the legs 50 move away from one another, being guided in the track 12, and when the actuator 49 is retracted, the ends 52 move toward one another. The holes 55 in the ends 52 of the legs 50 are preferably in an upper portion of each leg 50, although these holes could also be provided elsewhere in the leg 50. Optional rollers 22 may be provided at end 46 of cylinder 42 to roll in the track 12 and support that end of the cylinder 42 so as to take side loads off of the seal between the piston rod 34 and the cylinder 42.

As described above, a second set of holes 56 is provided spaced between the ends 52 and 53 of each leg 50, and preferably in a lower portion of each leg 50. A pin 58 is extended through the holes 56 to create a first pivotal connection between each leg 50 and an associated pair of links 60. At the opposing end, the links 60 are pivotally connected with bolts or pins to the bracket 62 that is welded or otherwise fixedly secured to the end of the rail 13. Thus, the links 60 can swing about a first horizontal axis through a pivot point 66 relative to the rail 13, and swing relative to the legs 50 about the horizontal axis about pins 58 that are spaced inwardly (toward the middle of rail 13) from pivots 66.

At the outer end 53 of each leg 50, the leg 50 is pivotally coupled to a foot 70 by a pivot pin 72 extending through the holes 57, as described above. Each foot 70 is preferably of relatively large area to disperse the force of the downward weight applied across a relatively large area. As discussed above with reference to the holes 55 and 56, the holes 57 are preferably provided in a lower portion of each leg 50.

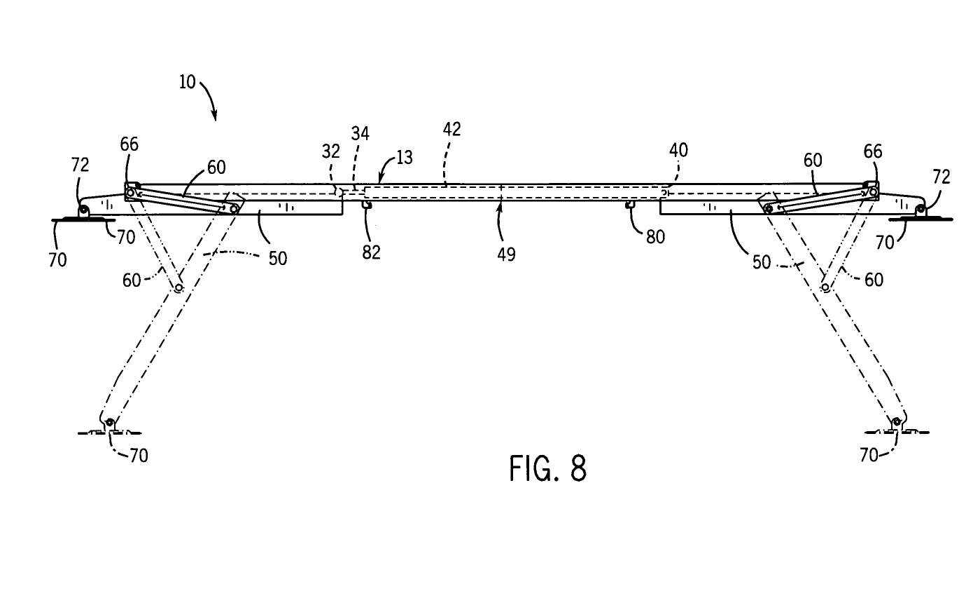

Referring now to FIG. 8, the legs 50 are shown in both a retracted or stored position, and in phantom in an active or extended position. To store the legs 50, the actuator 49 is retracted. As the piston rod 34 and cylinder end 40 are pulled toward the center of the track 12, the inner ends 52 of the legs 50 are also pulled inward toward the center of the track 12. As each leg 50 moves, it pivots about the pin 30 or 38 coupling the respective leg to either the piston rod 34 or end 40 of the cylinder 42, respectively. As the legs 50 pivot upward, the links 60 are pivoted upward around pivot point 66 and the legs 50 and feet 70 swing up toward the rail 13, into the track in moving the legs 50 into a stored position that is substantially parallel to the rail 13.

To put the legs 50 in the extended position, pressure is applied to the base side port 80, and the actuator 49 is extended. The inner ends 52 of the legs 50 are pushed outwardly away from one another, which, by virtue of the action of the wheels 18, 20, and 22 being guided by the track 12 and the links 60 pivoting relative to the track 12 and relative to the legs 50, causes the legs 50 to swing down toward a ground surface below the vehicle until the foot 70 contact the ground. If one of the legs 50 encounters the ground first, the end 52 of that leg will stop, and the end 52 of the opposite leg will proceed and may accelerate until the foot 70 on that leg 50 also contacts the ground. When that happens, the force of ground contact of each of the feet 70 will be split equally between them, since the forces being exerted on the ends 52 will be equal. In the final, retracted position, the legs 50 are angled with respect to the rail 13, typically at an angle between the stored parallel position described above, and a position in which the leg 50 is perpendicular to the rail 13. In the event that the foot does not touch the ground, rotation of the leg 50 is limited by the length of the link 60, which prevents rotation beyond a pre-selected angle.

Referring again to FIG. 1, in a recreational vehicle, one, two or more jacks 10, 11 may be provided for stabilizing the vehicle 8, depending on the size and configuration of the vehicle. If at least two of the jacks are used, one would typically be located near one end of the vehicle and the other would be at the other end, for example, one at the rear and one at the front, both extending laterally, to position one leg near each corner of the vehicle, as shown by jacks 10 and 11 of FIG. 1. To minimize the time and effort required in setting up a recreational vehicle, and also to keep the vehicle relatively level and stable as the jacks are being extended, it is desirable to have the jacks 10 and 11 extend and retract in coordination with one another. A single pump 84 including two extends ports 81 and 83 and two retract ports 85 and 87, as shown in FIG. 1, may be coupled to the actuator ports 80 and 82, respectively, in jacks 10 and 11 and therefore used to operate both jacks. The pump 84 can be operated by a 3-position switch 15 (FIG. 1.), having a limit switch 108 indicating an extend position, a limit switch 106 indicating a retract position, and an off position. In the off position, the pressures are held within each actuator 49 so that all motion of the legs 50 up or down is inhibited by the pressure. The limit switches 106, 108 are positioned adjacent each end 40, 46 of each actuator 49 to determine whether the piston rods 34 are fully extended or fully retracted.

Preferably, so that the jack 10 at one end of the vehicle 8 moves in coordination with the jack 11 at the other end, the control of one of the jacks 10 and 11 is dependent on the control of the other. Preferably, a flow divider circuit, as disclosed in U.S. Pat. Nos. 6,655,723, and 6,932,403, and U.S. patent application Ser. No. 11/184,141, all of which are incorporated herein by reference, is used for the two hydraulic circuits that extend and retract the cylinders 42 in the jacks 10 and 11. The flow divider maintains the flow of fluid to the two cylinders 42 at substantially equal flow rates to synchronize movement of the legs 50 of jack 10 at one end of the vehicle 8 with the movement of the legs 50 of jack 11 at the other end of the vehicle 8. Thus, in the arrangement described above, the jack 11 at the front end of the vehicle 8 would lift and lower at approximately the same rate as the jack 10 at the rear end of the vehicle 8.

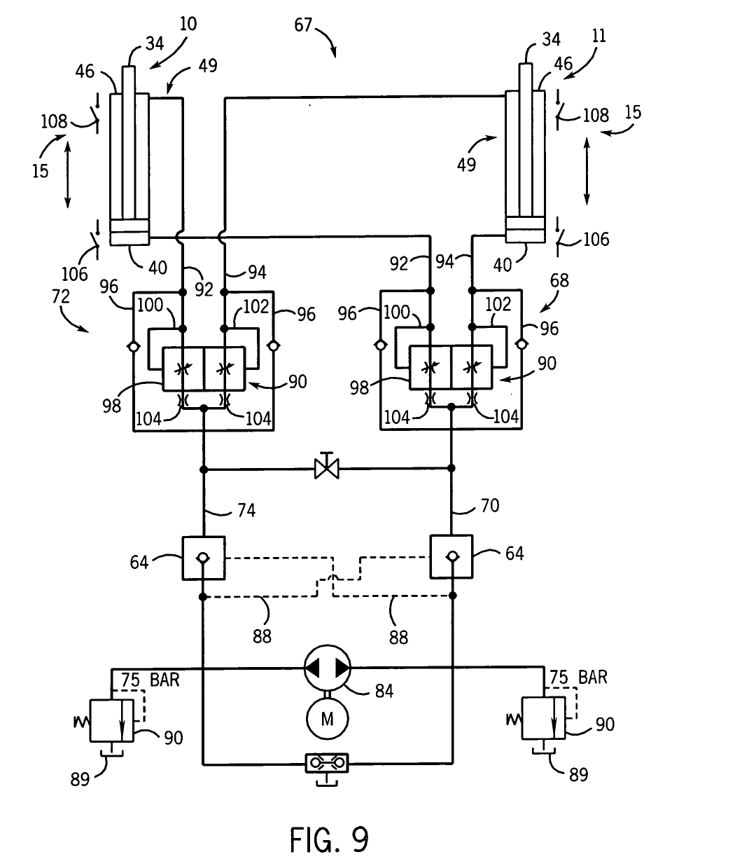

Referring now to FIG. 9, a hydraulic diagram for operation of the flow divider circuit in the present application is shown. The hydraulic actuators 49 for each jack 10 and 11 are actuated by a hydraulic circuit 67 which drives the piston rods 34 at approximately the same speed and time. The hydraulic circuit 67 includes an extension circuit 68 which supplies hydraulic fluid to the end 40 of each actuator 49 to extend the piston rods 34, and a retraction circuit 72 which supplies hydraulic fluid to the other end 46 of each actuator 49 to retract the piston rods 34. The pump 84 supplies fluid to the desired circuit 68, 72 depending upon whether the operator has chosen to extend or retract the legs 50. The pump 84 is electrically connected to an electronic control unit 78 (not shown) which monitors data from limit switches 106, 108 and controls operation of the pump 84 and the movement of the legs 50 in the track 12. A switch, such as a push button, signal from, for example, a remote radio frequency device can be used to provide a signal to the control to lower the sticks 10 and 11. Other methods of starting the leveling process will be apparent to those of skill in the art.

Referring still to FIG. 9, the extension circuit 68 and retraction circuit 72 are substantially identical except one supplies end 40 and the other supplies end 46 of the actuator 49 with hydraulic fluid. Accordingly, the following description is made with reference to the retraction circuit 72 with the understanding that the description also applies to the extension circuit 68.

The retraction circuit 72 includes a main supply line 70 having a pressure relief valve 90 and a pilot operated check valve 64. The pressure relief valve 90 is automatically opened to allow fluid to flow into a reservoir 89 when fluid pressure in the main supply line 80 exceeds a predetermined value.

The pilot operated check valve 64 operates to allow fluid to flow toward the actuators 49 and prevent the fluid from flowing in the reverse direction. A pilot line 88 connects the check valve 64 in the retraction circuit supply line 74 to an extension circuit supply line 70. A positive pressure in the extension circuit supply line 70 sensed by the pilot line 88 opens the check valve 64 to allow hydraulic fluid to flow in the reverse direction away from the actuators 49 past the check valve 64. For example, when the pilot line 88 connecting the retraction circuit check valve 64 and the extension circuit supply line 70 senses a positive pressure in the extension circuit supply line 70, the retraction circuit check valve 64 is opened to allow hydraulic fluid draining from the hydraulic actuator ends 46 to flow past the retraction circuit check valve 64 back toward to the pump 84. The fluid flowing back to the pump 84 is then pumped into the extension circuit supply line 74.

The retraction circuit supply line 74 supplies hydraulic fluid to a flow divider 90 which splits the hydraulic fluid between left and right branch lines 92, 94. Each branch line 92, 94 feeds the end 46 of one actuator 49. Drain lines 96 divert the flow of hydraulic fluid from each branch line 92, 94 around the flow divider 90 to the supply line 74 when evacuating fluid from the end 46 of the actuator 49.

The flow divider 90 diverts hydraulic fluid through the branch lines 92, 94 to the actuators 49 depending upon the hydraulic pressure in the actuators 49 using a pilot operated spool valve 98. A pilot line 100 in the left branch line 92 exerts a pressure against the spool valve 98 to urge the spool valve 98 toward the right against a pressure exerted by a second pilot line 102 in the right branch line 94 which urges the spool valve 98 to the left. Orifices 104 upstream of the spool valve 98 in each branch line 92, 94 prevent the flow of hydraulic fluid above a predetermined flow rate. Preferably, the predetermined flow rate is less than the flow rate capacity of the spool valve 98.

Moving the spool valve 98 to the right increases the flow of hydraulic fluid to the left branch line 92 while decreasing the flow of hydraulic fluid to the right branch line 94, and vice versa. As a result, when one branch line 92, 94 has a hydraulic fluid pressure which is greater than the other branch line 94, 92, more hydraulic fluid is diverted to the branch line 92, 94 having the greater pressure at the expense of the other branch line 94, 92. Advantageously, diverting hydraulic fluid to the branch line 92, 94 having a higher pressure using the flow divider 90 causes the piston rods 34 to move at the substantially same speed automatically by directing hydraulic fluid to the actuator 49 which is encountering more resistance than the other actuator 49, thus avoiding skewing. In addition, the flow divider ensures the elastomeric seal is uniformly compressed to provide a tight seal.

A preferred embodiment of the invention has been described in considerable detail. Many modifications and variations to the preferred embodiment described will be apparent to a person of ordinary skill in the art. Therefore, the invention should not be limited to the embodiment described.

I/we claim:

1. In a jack having a rail with a leg pivotally connected at each end of the rail, the improvement wherein inner ends of the legs are guided in a track of the rail so as to move linearly in the track and wherein a linear actuator moves the ends toward and away from one another to retract and extend the legs.

2. The improvement of claim 1, wherein the linear actuator is a hydraulic actuator.

3. The improvement of claim 2, wherein the hydraulic actuator includes a cylinder, and both ends of the cylinder are guided in the track.

4. The improvement of claim 1, wherein the rail is four-sided, having a central slot formed in a bottom side of the rail.

5. The system including two jacks as claimed in claim 1, further comprising a hydraulic circuit for extending and retracting the jacks, and wherein the hydraulic circuit includes a flow divider providing substantially equal flow to each of the two jacks.

6. A stabilizer jack comprising:
an elongate rail including a track;
an actuator movably received in the track;
a first leg and a second leg, an inner end of each of the first and second legs being pivotally coupled to opposing ends of the actuator within the track;
wherein the actuator is selectively activatable to cause the legs to move linearly in the track away from one another and to pivot between a stored position wherein the legs are substantially parallel to the rail and an extended position in which the legs are pivoted downward to drive an outer end of each leg toward a surface below the rail.

7. The stabilizer jack as defined in claim 6, further comprising a first and a second roller, the first and second rollers being coupled to the inner ends of the corresponding first and second legs and to opposing ends of the actuator for guiding the actuator and the legs in the track.

8. The stabilizer jack as defined in claim 6, wherein the actuator includes a cylinder, and opposing ends of the cylinder are guided in the track.

9. The stabilizer jack as defined in claim 6, further comprising a first and a second foot, the first and second foot being pivotally coupled to an outer end of the corresponding first and second leg.

10. The stabilizer jack as recited in claim 6, wherein the inner end of the first leg is coupled to a piston rod extending from a rod end of the cylinder and the inner end of the second leg is coupled to a base end of the cylinder.

11. The stabilizer jack as recited in claim 10, further comprising a first roller coupled to the rod end of the cylinder, a second roller coupled to the base end of the cylinder, and a third roller to an end of the piston rod.

12. The stabilizer jack as recited in claim 6, wherein the rail is substantially rectangular in shape and includes a slot provided in a bottom wall of the rail and extending from a first end of the rail to a second end of the rail to form the track in the rail.

13. The stabilizer jack as recited in claim 6, further comprising a link pivotally coupled between the rail and each of the legs, the link limiting the rotational motion of the legs in the extended position.

14. A jacking system for a recreational vehicle, the jacking system comprising:
a first jack and a second jack, each jack having a rail including a track for receiving a dual-acting cylinder and first and second legs, the first and second legs having inner ends pivotally connected at each end of the cylinder such that the legs are guided in the track of the rail to move linearly toward and away from one another between a retracted and an extended position as the cylinder is retracted and extended, respectively; and
a flow divider circuit including at least two fluid ports, one of said fluid ports being in fluid communication with the dual-acting cylinder in the first jack and the other being in fluid communication with the dual-acting cylinder in the second jack, wherein said flow divider equalizes the flow of fluid flowing through said ports at substantially equal flow rates regardless of the fluid pressure in the cylinders in the respective first and second jacks to synchronize movement of the first and second legs in the first and second jacks.

15. The jacking system as recited in claim 14, wherein the first jack is adapted to be coupled to a first end of a recreational vehicle, and the second jack is adapted to be coupled to an opposing end of the recreational vehicle.

16. The jacking system as recited in claim 14, further comprising a roller coupled to each end of the dual-acting cylinder in each of the first and second jacks.

17. The jacking system as recited in claim 14, further comprising a foot pivotally coupled to the outer end of each leg.

18. The jacking system as recited in claim 14, further comprising a link pivotally coupled between the rail in each jack and each leg, the links limiting the rotation of the legs in the extended position.

19. The jacking system as recited in claim 14, wherein the inner end of one of the legs is coupled to a piston rod, and the piston rod is coupled to a roller sized and dimensioned to roll through the track.

20. The jacking system as recited in claim 14, wherein the rail is four-sided, having a central slot formed in a bottom side of the rail.
